(19) United States
(12) Patent Application Publication
(10) Pub. No.: US 2019/0036604 A1
(43) Pub. Date: Jan. 31, 2019

(54) VISIBLE LIGHT COMMUNICATION (VLC) VIA DIGITAL IMAGER

(71) Applicant: QUALCOMM Incorporated, San Diego, CA (US)

(72) Inventors: Bapineedu Chowdary Gummadi, Hyderabad (IN); Ravi Shankar Kadambala, Hyderabad (IN); Vivek Veenam, Hyderabad (IN)

(21) Appl. No.: 15/664,079

(22) Filed: Jul. 31, 2017

(51) Int. Cl. H04B 10/116; H04B 10/075

(52) U.S. Cl. CPC H04B 10/116; H04B 10/075

(57) ABSTRACT

Briefly, one particular example implementation is directed to an apparatus including a digital imager. In the particular example implementation, the image includes an array of pixels, in which at least some pixels are dedicated to measure light component signals, such as for an image, and at least other pixels are dedicated to measure Visible Light Communication (VLC) signals. It should be understood that the aforementioned particular implementation is merely an example and claimed subject matter is not necessarily limited to any particular aspect of this example implementation.

### BACKGROUND

### 1. Field

The present disclosure relates generally to visible light communication (VLC) via a digital imager (DI).

### 2. Information

Recently, wireless communication employing light emitting diodes (LEDs), such as visible light LEDs, has been developed to complement radio frequency (RF) communication technologies. Light communication, such as Visible Light Communication (VLC), as an example, has advantages in that VLC enables communication via a relatively wide bandwidth. VLC also potentially offers reliable security and/or low power consumption. Likewise, VLC may be employed in locations where use of other types of communications, such as RF communications, may be less desirable. Examples may include in a hospital or on an airplane.

### SUMMARY

Briefly, one particular example implementation is directed to an apparatus including a digital imager (DI). Herein, the terms imager, imaging device or the like are intended to refer to a digital imager (DI). In the particular example implementation, the digital imager includes an array of pixels, in which at least some pixels are dedicated to measuring light component signals, such as for an image, and at least other pixels are dedicated to measuring Visible Light Communication (VLC) signals.

Another particular example implementation is directed to a non-transitory storage medium comprising executable instructions stored thereon, the instructions being accessible from the non-transitory storage medium as physical memory states on one or more physical memory devices, the one or more physical memory devices to be coupled to one or more processors able to execute the instructions stored as physical memory states, one or more of the physical memory devices also able to store binary digital signal quantities, if any, as physical memory states, that are to result from execution of the executable instructions on the one or more processors; wherein the executable instructions to measure light signals to imping upon an array of pixels, wherein at least some pixels of the array of pixels being dedicated to measure light component signals for an image and at least other pixels of the array of pixels being dedicated to measure visible light communication (VLC) signals.

Another particular example implementation is directed to a digital imager comprising: means for exposing an array of pixels to one or more light signals; and means for measuring at least a portion of the one or more light signals impinging upon the array of pixels, wherein at least some pixels of the array of pixels are dedicated to measure light component signals for an image and at least other pixels of the array of pixels are dedicated to measure visible light communication (VLC) signals.

Another particular example implementation is directed to measuring light signals impinging upon an array of pixels in a digital imager, wherein at least some pixels of the array of pixels being dedicated to measure light component signals for an image and at least other pixels of the array of pixels being dedicated to measure visible light communication (VLC) signals; and processing measured VLC signals impinging upon the at least other pixels of the array of pixels dedicated to measure VLC signals.

It should be understood that the aforementioned particular implementations are merely examples, and that claimed subject matter is not necessarily limited to any particular aspect of these example implementations.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram illustrating an embodiment of one possible architecture for a system including a digital imager;

FIG. 2 is an example array of pixels for an embodiment of a digital imager capable of capturing VLC signals;

FIG. 3 is a schematic diagram illustrating another embodiment of an architecture for a system including a digital imager;

FIGS. 4A and 4B are flow diagrams of actions to process light signal measurements substantially according to embodiments;

FIG. 5 is a schematic diagram illustrating another embodiment of an architecture for a system including a digital imager;

FIG. 6 is a schematic diagram illustrating features of a mobile device according to an embodiment; and

FIG. 7 is a flow diagram of actions to process an array of pixels according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

A typical VLC system generally may include various VLC devices, such as a light source, which may, for example, comprise an access point (AP), such as a base station, for example. Alternatively, however, as discussed below, for one directional communication, e.g., a downlink without an uplink, for example, a modulating light source may be available that does not necessarily comprise an access point. Likewise, a VLC terminal may comprise a VLC receiver that does not necessarily otherwise communicate (e.g., transmit) VLC signals, for example. Nonetheless, a VLC terminal may, in an example embodiment, likewise comprise a portable terminal, such as a cellular phone, a Personal Digital Assistant (PDA), a tablet device, etc., or a relatively fixed terminal, such as a desktop computer. For situations employing a AP and a VLC terminal in which communication is not necessarily one directional, such as having an uplink and a downlink, so to speak, for example, a VLC terminal may also communicate with another VLC terminal by using visible light in an embodiment. Furthermore, VLC may also in some situations be used effectively in combination with other communication systems employing other communication technologies, such as systems using a variety of possible wired and/or wireless signal communication approaches.

VLC signals may use light intensity modulation for communication. VLC signals, which may originate from a modulating light source, may, for example, be detected and decoded by an array of photodiodes, as one example. Likewise, a digital imager having electro-optic sensors, such as complementary metal oxide semiconductor (CMOS) sensors and/or charge coupled device (CCD) sensors, may include a capability to communicate via VLC signals in a similar manner (e.g., via detection and decoding). Likewise, a digital imager may be included within another device, which may be mobile in some cases, such as a smart phone, a tablet or may be relatively fixed, such as a desktop computer, etc.

However, default exposure settings for a digital imager, for example, may more typically be of use in digital imaging (e.g., digital photography) rather than for use in VLC signal communications. As such, default exposure settings may in some cases result in attenuation of VLC signals with a potential to possibly render VLC signals undetectable and/or otherwise unusable for communications. Nonetheless, as described, a digital imager (DI) may be employed, in an embodiment, in a manner that may permit VLC signal communications to occur, which may be beneficial, such as in connection with position/location determination(s), for example.

Global navigation satellite system (GNSS) and/or other like satellite positioning systems (SPSs) have enabled navigation services for mobile devices, such as handsets, in typically outdoor environments. However, satellite signals may not necessarily be reliably received and/or acquired in an indoor environment; thus, different techniques may be employed to enable navigation services for such situations. For example, mobile devices typically may obtain a position fix by measuring ranges to three or more terrestrial wireless access points, which may be positioned at known locations. Such ranges may be measured, for example, by obtaining a media access control (MAC) identifier or media access (MAC) network address from signals received from such access points and by measuring one or more characteristics of signals received from such access points, such as, for example, received signal strength indicator (RSSI), round trip delay (RTT), etc., just to name a few examples.

However, it may likewise be possible to employ Visible Light Communication technology as an indoor positioning technology, using, for example, in one example embodiment, stationary light sources comprising one or more light emitting diodes (LEDs). In an example implementation, fixed LED light sources, such as may be used in a light fixture, for example, may broadcast positioning signals using relatively rapid modulation, such as of light intensity level (and/or other measure of amount of light generated) in a way that does not significantly affect illumination otherwise being provided.

In an embodiment, for example, a light fixture may provide a VLC signal with a unique identifier to differentiate a light fixture from other light fixtures out of a group of light fixtures, such as in a venue, for example. A map of locations of light fixtures and corresponding identifiers, such as for a venue, for example, may be stored on a remote server, for example, to be retrieved. Thus, a mobile device may download and/or otherwise obtain a map via such a server, in an embodiment, and reference it to associate a fixture identifier with a decoded VLC signal, in an example application.

From fixture identifiers alone, for example, a mobile device may potentially determine its position to within a few meters. Likewise, with additional measurement and processing of VLC signals, in an embodiment, a mobile device may potentially further narrow its position, such as to within a few centimeters. An array of pixels (e.g., pixel elements) of a digital imager, may be employed for measuring appropriately modulating VLC signals from one or more LEDs, for example. In principle, a pixel in an array of a DI accumulates light energy coming from a relatively narrow set of physical directions. Thus, processing of signals captured via pixels of an array of a DI may facilitate a more precise determination regarding direction of arrival of light so that a mobile device, for example, may compute its position to within a few centimeters, as suggested, relative to a light fixture that has generated such modulated signals. Thus, as an example embodiment, signal processing may be employed to compute position/location, such as by using a reference map and/or by using light signal measurements, such as VLC signals, to further narrow location/position.

In one example implementation, as an illustration, different colored trans-missive films may be formed over individual electro-optic sensors in an array in a so-called Bayer pattern. Thus, the films may operate as color filters for individual electro-optic sensors. However, processing VLC signals with a full pixel array of a digital imager, for example, may consume excessive amounts of relatively scarce power and/or may use excessive amounts of available memory, which also comprises a limited resource typically, such as for a mobile device. Furthermore, it is possible in some cases for use of colored trans-missive films to potentially reduce sensitivity to VLC signals.

One approach may be to adjust exposure time for electro-optic sensors of a DI based at least in part on presence of detectable VLC signals. For example, a digital imager, such as for a mobile device, in one embodiment, may employ an electronic shutter to read and/or capture a digital image one line (e.g., row) of a pixel array at a time. Exposure may, for example, in an embodiment, be adjusted by adjusting read and reset operations as rows of an array of pixels are processed. Thus, it might be possible to adjust read and reset operations so that exposure to light from a timing perspective, for example, is more conducive to VLC processing. However, one disadvantage may be that doing so may interfere with typical digital imager operation (e.g., operation to produce digital images).

In an embodiment, nonetheless, a subset of electro-optic sensors in an array of pixels of DI may be dedicated to capturing light in a mode suitable for VLC operations (e.g., measuring light signals, such as light intensity, for example). For example, in one embodiment, photodiodes, as an example, dedicated to capturing light for VLC signal processing, may be employed potentially with reduced power consumption and/or improved measurement sensitivity. However, claimed subject matter is, of course, not limited to employing photodiodes. Likewise, other types of electro-optic sensors may also be dedicated to capturing light for VLC signal processing, such as CCD and/or CMOS sensors, for example

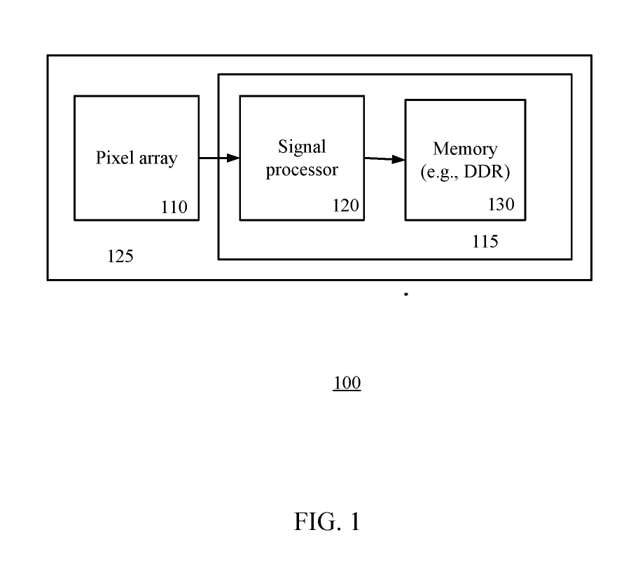

FIG. 1 is a schematic diagram illustrating a possible embodiment, such as 100, of an architecture for processing light signals (e.g., light signal measurements) received at a DI of a mobile device (e.g., in a smartphone). Thus, as illustrated in this example, a digital imager 125 may include a pixel array 110, a signal processor (SP) 120 and memory 130, such as double data rate (DDR) memory, for example, in one embodiment. As shall be described, circuitry, such as circuitry 115, which includes SP 120 and memory 130, may respectively extract measured VLC signals and measured light component signals (e.g., for an image) from light signal measurements captured by an pixels of array 110, for example. Thus, as an example, in an embodiment, an array, such as 110, may include at least some pixels dedicated to measuring VLC signals and at least some other pixels dedicated to measuring light component signals (e.g., for an image), as described in more detail below. Likewise, the respective signals (e.g., measured VLC signals and measured light component signals, respectively) captured in an array via separate pixels may undergo separate and distinct “downstream” processing from the array of pixels in a device, such as a mobile device, for a selected embodiment. For example, measured VLC signals and measured light component signals may be separately assembled from light signal measurements captured via an array of pixels, for example, so that concurrent processing may take place, such as VLC decoding for the measured VLC signals and image processing for the measured light component signals, in an embodiment.

Extraction, assembly and processing of signals from an array of pixels may be accomplished in a variety of approaches, with more than one described below for purposes of illustration. Of course, claimed subject matter is not intended to be limited to examples, such as those described for purposes of illustration. That is, other approaches are also possible and intended to be included within claimed subject matter. However, one possible advantage of an embodiment may include employing a DI in a manner to capture and process VLC signal measurements while also concurrently capturing and processing light component signal measurements (e.g., for a digital image). It is noted, as discussed in more detail below, this may be accomplished in an example embodiment via an implementation or embodiment that includes a combination of hardware and software, for example, which may provide some advantages, including greater flexibility to employ different signal processing approaches, for example, as mentioned below.

Thus, for illustration, in an embodiment, SP 120 may include executable instructions to perform “front-end” processing (such as visible light front end processing (e.g., VFE)) of light component signals from an array, such as 110. For example, in an embodiment, an array of pixels may not necessarily be selectively addressable pixel-by-pixel. Instead, as one example, an array of pixels may be processed row by row. That is, for example, signals (e.g., light signal measurements) captured by a row of pixels of an array, such as 110, may be provided to SP 120 so that a frame of an image, for example, may be constructed (e.g., assembled from rows of signals), in “front end” processing.

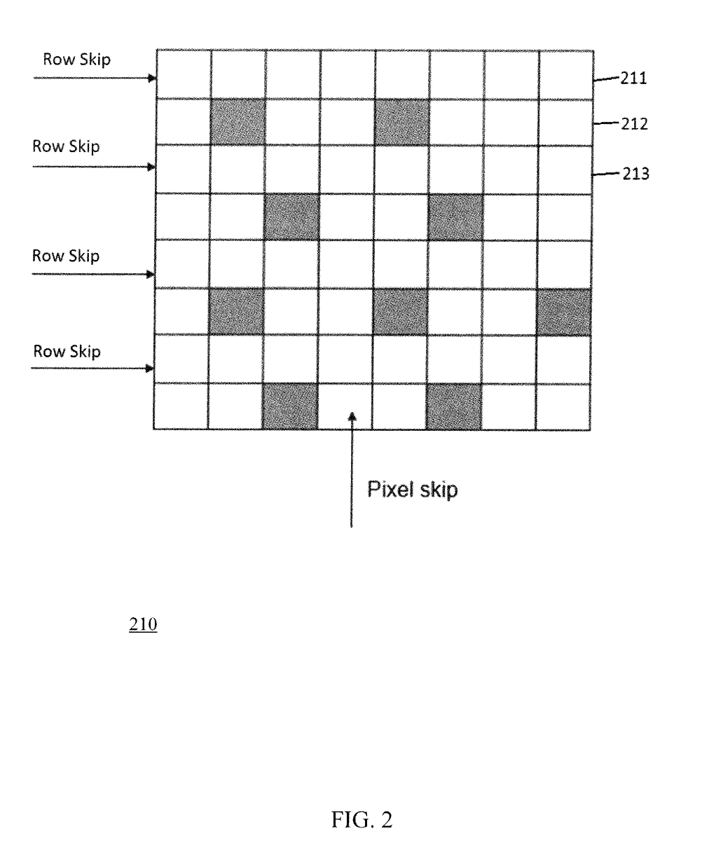

However, as suggested previously, in an embodiment in which at least some pixels of an array are dedicated to measure VLC signals, rather than to measure light component signals for an image to be assembled, SP 120 may further include executable instructions to selectively parse signals (e.g., signal measurements) corresponding to those pixels dedicated to measuring VLC signals. Referring to FIG. 2, 210 comprises as an example of an array of pixels. Thus, in this illustration, through row by row processing, VLC signals may be parsed from light signals (e.g., signal measurements) captured by an array of a digital imager, for example, for measuring light components signals, such as for an image, for example.

Referring to FIG. 2 as an illustration, dark squares denote pixels dedicated to measure VLC signals. In an embodiment, for example, photodiodes may be employed; however, as previously indicated likewise other types of electro-optic sensors may be similarly employed. Likewise, of course, in addition to employing a variety of types of sensors in an array of pixels, likewise, the number of pixels and/or the layout of the pixels may vary. Thus, for example, pixels dedicated to measure VLC signals may similarly vary in type, number and/or layout. Furthermore, shape and/or size of pixels for an array may also vary. Thus, it is intended that claimed subject matter include a host of different possible arrays that may be employed as an array of pixels.

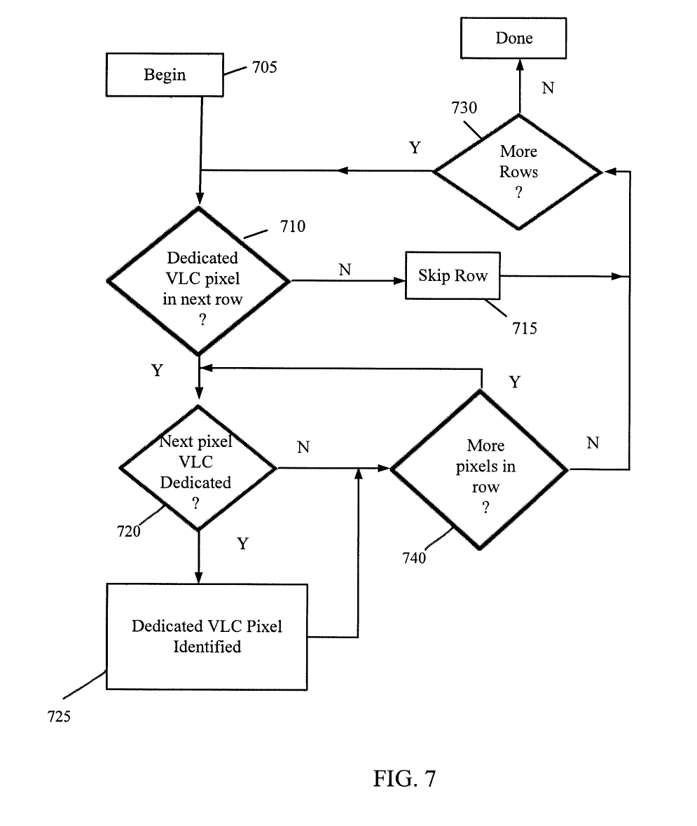

Likewise, as an illustration, one embodiment of an approach to processing pixels of an array is discussed; however, it is understood that claimed subject matter is not intended to be limited in scope of an illustrative embodiment. For example, FIG. 7 includes a flow diagram to be discussed in connection with the illustrative example of FIG. 2. FIG. 7 describes a process in which pixels of an array dedicated for use in VLC signal processing (e.g., dark squares shown in FIG. 2) are identified so that VLC signals can be measured.

Processing of the array in this illustration is from the top of FIG. 2. FIG. 7 begins at block 705. This leads to block 710, in which it is determined whether the next row includes pixels dedicated to be used for VLC. Of course, at initiation of processing, the next row refers to the first row, here row 211. Thus, because row 211 has no pixels, at 715, row 211 is skipped and a loop is made back to 710, in which a determination regarding a successive (e.g., next row) is made. Likewise, successive row 212 shown in FIG. 2 includes dark squares. However, viewing processing of a row from the left of FIG. 2 in this illustration, at block 720 a determination is made whether a next pixel is a pixel dedicated for VLC signal processing. Since for row 212, initiation of processing of that row is commenced, the next pixel is an initial pixel of row 212. Here, that pixel may be skipped. However, since the row includes more pixels, at 740 a loop is made back to 720. At 720 and then block 725, the second pixel of the row is identified as a VLC dedicated pixel; continuing the process, the third and fourth pixels of row 212 are skipped before identifying another VLC dedicated pixel in row 212, and so on.

Processing via SP 120 in accordance with executable instructions may be referred to as software or firmware extraction of VLC signals (e.g., via execution of instructions by a signal processor, such as 120). Thus, in an embodiment, for example, SP 120 may execute instructions to perform extraction of VLC signals out of a captured image frame, or a portion thereof, and to perform additional processing, such as field of view (FOV) assembly of VLC signals and/or frame assembly of light component signals for an image. It is noted here that FOV assembly of VLC signals may be advantageously performed via execution of instructions on a SP, such as 120. For example, a mobile device may be in motion as signals are captured and, likewise, movement toward or away from a light source, such as a light fixture generating modulating light signals, may lead to dynamic adjustment of a FOV as it is being assembled. Thus, for example, in an embodiment, a SP programmed appropriately may provide such a capability. Thus, as mentioned, flexibility in terms of signal processing approaches may be possible for such an embodiment.

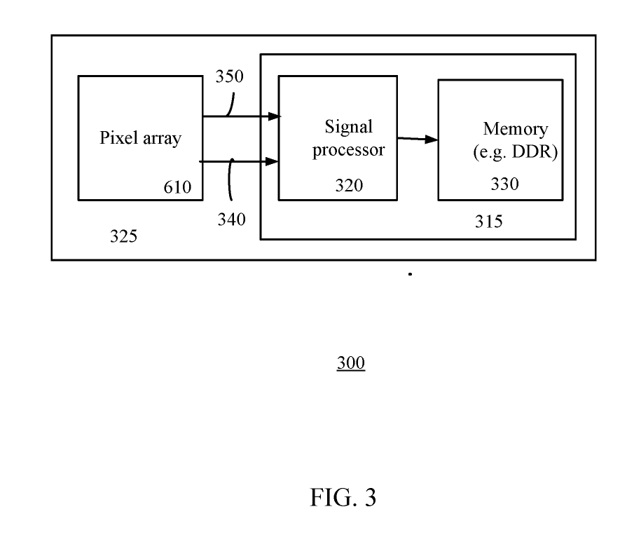

In contrast to FIG. 1, FIG. 3 is a schematic diagram illustrating an alternative possible embodiment, such as 300, of an architecture for processing light signals received at a DI of a mobile device (e.g., in a smartphone). Thus, as illustrated in FIG. 3, a digital imager 325 may include pixel array 310, a signal processor (SP) 320 and memory 330, as such DDR memory, for example, in one embodiment. Likewise, as was previously described, circuitry, such as circuitry 315, which includes SP 320 and memory 330, may be used to respectively extract measured VLC signals and to extract measured light component signals from respectively separate pixels of an array, such as array 610, for example, employed to capture an image frame or a portion thereof. For example, an array, such as 610, may include some pixels dedicated to measuring VLC signals and other pixels dedicated to measuring light component signals (e.g., for an image). Likewise, as before, respective signals may undergo separate and distinct processing. For example, in an embodiment, measured VLC signals may be assembled and provided to a VLC decoder. Likewise, along a different, separate signal path, for example, measured light component signals may be assembled for image processing so that concurrent processing of measured VLC signals and measured light component signals may be possible

Thus, FIG. 3, for example, illustrates separate signal paths, 340 and 350, respectively, from pixel array 310, for an embodiment. Thus, while path 340 may provide measured light component signals to SP 320 on a row by row basis, in an embodiment, for example, path 350 may provide measured VLC signals to SP 320 for different “front end” (e.g., VFE) processing. For example, path 340 may comprise a primary signal path from array 310 whereas path 350 may comprise a remote signal interface path, sometimes referred to as an RDI path, that may be available. Thus, FIG. 3 illustrates an example embodiment in which measured VLC signals may be extracted from pixel array 310 via specific hardware rather than employing a SP, such as 320, to execute instructions to perform signal parsing, as previously described. An embodiment in which signals may be extracted from an image frame or portion thereof via specific hardware, in comparison with an embodiment in which extraction may be performed via execution of instructions by a SP, as described above, has a potential to possibly provide faster processing and/or less power consumption, such as if processing is concurrently performed and/or SP execution is not involved in signal extraction.

Of course, in an embodiment, if employing dedicated pixels, for example, fewer electro-optic sensors are available for measuring light signal components for an image; however, the number of dedicated pixels may in general be relatively small in comparison to the size of an overall array. For example, in an implementation, 32 pixels of a 64-by-64-pixel array may comprise dedicated pixels, which, in this example, is less than 1.0 percent (e.g., 0.78 percent). Furthermore, although fewer electro-optic sensors may be available for measuring light signal components for an image, in an embodiment, image processing of light component signals may employ pixel correction, tune device thresholds for sensors of a pixel array and/or employ defect pixel correction (DPC) for pixels of an array dedicated to VLC signals. Various approaches to DPC are known and need not be described in further detail. Thus, DI performance may not be significantly affected in that specific regions that include pixels dedicated to VLC signals may be processed to omit or reduce potential pixel defects that might otherwise result. It is likewise noted that processes to manufacture different types of electro-optic sensors for an array, assuming in an embodiment dedicated pixels may comprise different type of sensors, nonetheless may employ similar fabrication operations. Thus, potentially manufacturing costs to employ a manufacturing process in which an array of pixels is formed (e.g., made) to include different types of electro-optic sensors (e.g., photodiodes and CCDs; photodiodes and CMOS devices; etc.) may not necessarily be significantly affected.

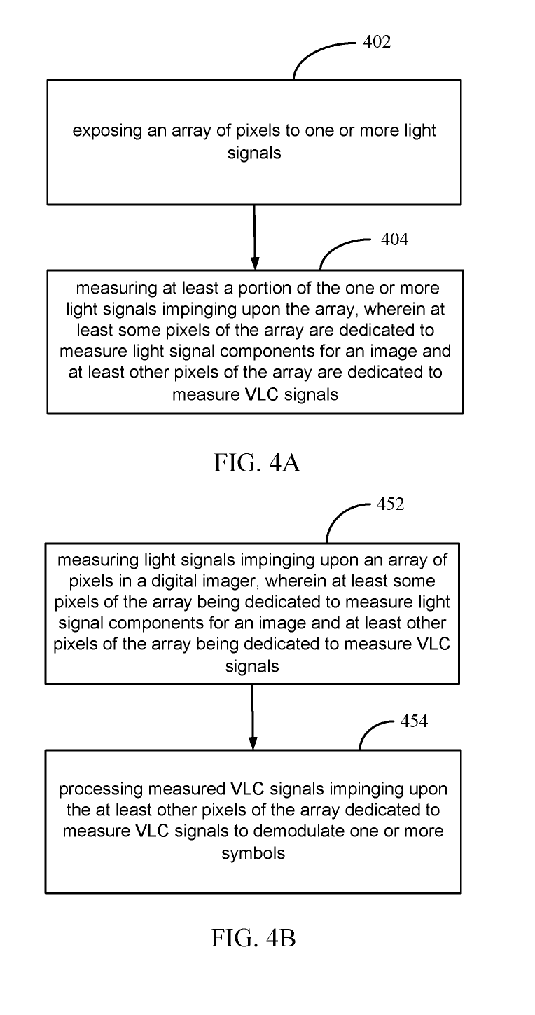

FIGS. 4A and 4B illustrate flowcharts for illustrative embodiments for measuring and processing VLC signals via a DI. It should also be appreciated that even though one or more operations are illustrated and/or may be described concurrently and/or with respect to a certain sequence, other sequences and/or concurrent operations may be employed, in whole or in part. In addition, although the description below references particular aspects and/or features illustrated in certain other figures, one or more operations, including other operations, may be performed with other aspects and/or features. For example, referring to FIG. 4A, at block 402, an array of pixels, such as 110 or 610, previously described, as examples, may be exposed to one or more light signals. At block 404, an array of pixels is exposed to light. Thus, a portion of the one or more light signals impinging upon the pixels of the array may be measured, such as by signal sampling, for example. It is noted that terms such as exposed, impinging upon or the like are intended to be interchangeable without loss of meaning. Likewise, it is intended that measuring light signals captured by one or more pixels of an array may or may not include signal sampling. The term signal sampling refers to measuring a signal value level of a signal at a chosen instant in time and may, as one example, be employed, such as in situations in which a signal value level has a potentially to vary in signal value level over time. Some pixels of the array may be dedicated to measuring light signal components; likewise, other pixels of the array may be dedicated to measuring VLC signals. Likewise, measuring light signals, such as VLC signals, of pixels may comprise selectively measuring light signals of particular pixels of an array.

Similarly, referring to FIG. 4B, after measuring impinging light samples at block 452, processing of VLC signals (e.g., signal samples) measured by pixels dedicated to measuring VLC signals may be performed at block 454. For example, VLC signals (e.g., signal samples) which have been modulated by a light source may be demodulated. Likewise, demodulated light signals (e.g., samples) may further be decoded to obtain an identifier in an embodiment. In one example implementation, a decoded identifier may be used in positioning operations, as described previously, for example, to associate a location of a light source with a decoded identifier and to estimate a location of a mobile device, for example, based at least partially on measurements of VLC signals. In another example implementation, block 454 may demodulate one or more symbols in a message or a packet, such as may be communicated. As previously described, measuring light signals may involving use of signal sampling. Depending at least in part on implementation, a symbol in a message or a packet may comprise one or more such signal samples for implementations in which sampling may be employed.

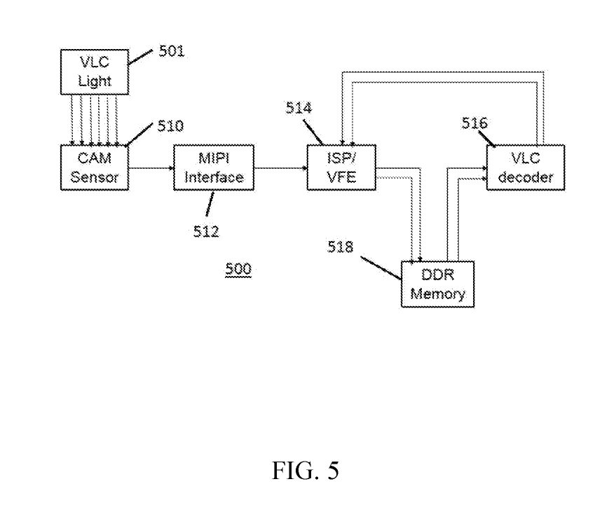

FIG. 5 is a schematic diagram illustrating another embodiment 500 of an architecture for a system including a digital imager. Embodiment 500 is a more specific implementation, again provided merely as an illustration, and not intended to limit claimed subject matter. In many respects, it is similar to previously described embodiments, such as including an array of pixels (e.g., 110, 210 or 610, mentioned previously), at 510, including a signal processor, such as image signal processor (ISP) 514, and including a memory, such as DDR memory 518. FIG. 5, as shown, illustrates VLC light signals from a VLC light 510 impinging upon 510. It is noted, however, that in embodiment 500, before image signal processor 514, which implements a visible light processing front end (VFE), signals from a pixel array may pass via a mobile industry processor interface (MIPI), which may provide signal standardization as a convenience. It is noted that the term “MIPI” refers to any and all past, present and/or future MIPI Alliance specifications. MIPI Alliance specifications are available from the MIPI Alliance, Inc. Likewise, after front end (e.g., VFE) processing, signals may be provided to memory. VLC light signals, for example, after being provided in memory, may be decoded by decoder 516 and then may return to ISP 514 for further processing, such as described previously for use in positioning, such as previously described.

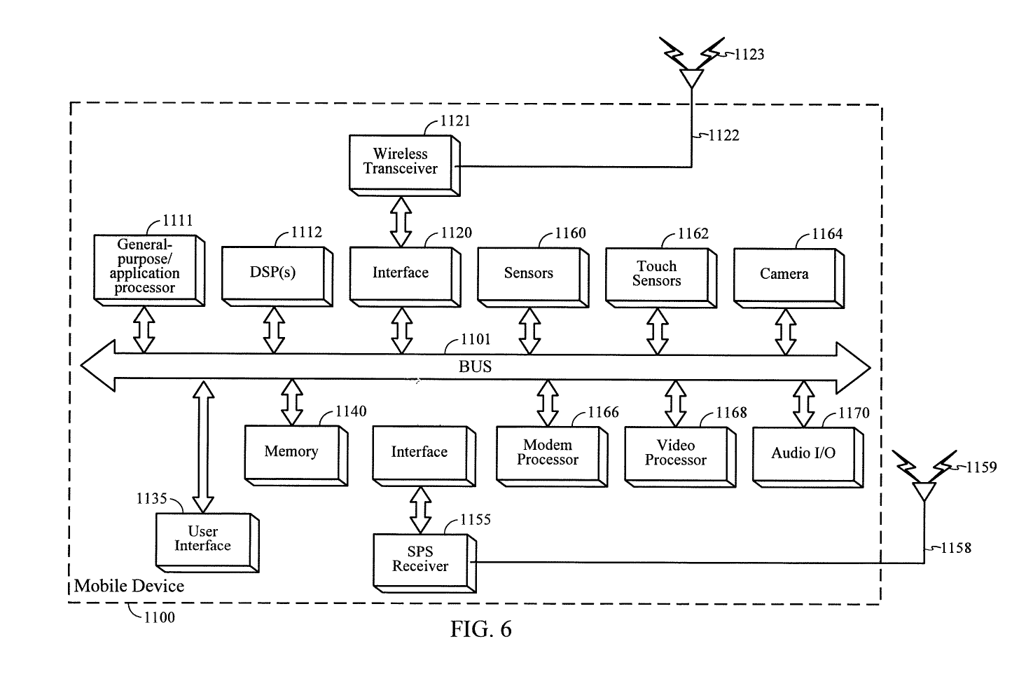

FIG. 6 is a schematic diagram illustrating features of a mobile device according to an embodiment. Subject matter shown in FIG. 6 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure, as are the terms “computing device,” “mobile device,” “wireless station,” “wireless transceiver device” and/or similar terms. However, if it is determined, for some reason not immediately apparent, that the foregoing understanding cannot stand, then, it is intended is to be understood and to be interpreted that, by the use of the term “computing device,” “mobile device,” “wireless station,” “wireless transceiver device” and/or similar terms, corresponding structure, material and/or acts for performing one or more actions for the present disclosure comprises at least FIGS. 4A and 4B, and any associated text.

In certain embodiments, mobile device 1100 may also comprise a wireless transceiver 1121 which is capable of transmitting and receiving wireless signals 1123 via wireless antenna 1122 over a wireless communication network. Wireless transceiver 1121 may be connected to bus 1101 by a wireless transceiver bus interface 1120. Wireless transceiver bus interface 1120 may, in some embodiments be at least partially integrated with wireless transceiver 1121. Some embodiments may include multiple wireless transceivers 1121 and wireless antennas 1122 to enable transmitting and/or receiving signals according to a corresponding multiple wireless communication standards such as, for example, versions of IEEE Std. 802.11, CDMA, WCDMA, LTE, UMTS, GSM, AMPS, Zigbee, Bluetooth or other wireless communication standards mentioned elsewhere herein, just to name a few examples.

Mobile device 1100 may also comprise SPS receiver 1155 capable of receiving and acquiring SPS signals 1159 via SPS antenna 1158. For example, SPS receiver 1155 may be capable of receiving and acquiring signals transmitted from one global navigation satellite system (GNSS), such as the GPS or Galileo satellite systems, or receiving and acquiring signals transmitted from any one several regional navigation satellite systems (RNSS') such as, for example, WAAS, EGNOS, QZSS, just to name a few examples. SPS receiver 1155 may also process, in whole or in part, acquired SPS signals 1159 for estimating a location of mobile device 1000. In some embodiments, general-purpose processor(s) 1111, memory 1140, DSP(s) 1112 and/or specialized processors (not shown) may also be utilized to process acquired SPS signals, in whole or in part, and/or calculate an estimated location of mobile device 1100, in conjunction with SPS receiver 1155. Storage of SPS or other signals for use in performing positioning operations may be performed in memory 1140 or registers (not shown). Mobile device 1100 may provide one or more sources of executable computer instructions in the form of physical states and/or signals (e.g., stored in memory such as memory 1140). In an example implementation, DSP(s) 1112 or general-purpose processor(s) 1111 may fetch executable instructions from memory 1140 and proceed to execute the fetched instructions. DSP(s) 1112 or general-purpose processor(s) 1111 may comprise one or more circuits, such as digital circuits, to perform at least a portion of a computing procedure and/or process. By way of example, but not limitation, DSP(s) 1112 or general-purpose processor(s) 1111 may comprise one or more processors, such as controllers, microprocessors, microcontrollers, application specific integrated circuits, digital signal processors, programmable logic devices, field programmable gate arrays, the like, or any combination thereof. In various implementations and/or embodiments, DSP(s) 1112 or general-purpose processor(s) 1111 may perform signal processing, typically substantially in accordance with fetched executable computer instructions, such as to manipulate signals and/or states, to construct signals and/or states, etc., with signals and/or states generated in such a manner to be communicated and/or stored in memory, for example.

Memory 1140 may also comprise a memory controller (not shown) to enable access of a computer-readable storage medium, and that may carry and/or make accessible digital content, which may include code, and/or computer executable instructions for execution as discussed above. Memory 1140 may comprise any non-transitory storage mechanism. Memory 1140 may comprise, for example, random access memory, read only memory, etc., such as in the form of one or more storage devices and/or systems, such as, for example, a disk drive including an optical disc drive, a tape drive, a solid-state memory drive, etc., just to name a few examples. Under direction of general-purpose processor(s) 1111, DSP(s) 1112, video processor 1168, modem processor 1166 and/or other specialized processors (not shown), a non-transitory memory, such as memory cells storing physical states (e.g., memory states), comprising, for example, a program of executable computer instructions, may be executed by general-purpose processor(s) 1111, memory 1140, DSP(s) 1112, video processor 1168, modem processor 1166 and/or other specialized processors for generation of signals to be communicated via a network, for example. Generated signals may also be stored in memory 1140, also previously suggested.

Memory 1140 may store electronic files and/or electronic documents, such as relating to one or more users, and may also comprise a device-readable medium that may carry and/or make accessible content, including code and/or instructions, for example, executable by general-purpose processor(s) 1111, DSP(s) 1112, video processor 1168, modem processor 1166 and/or other specialized processors and/or some other device, such as a controller, as one example, capable of executing computer instructions, for example. As referred to herein, the term electronic file and/or the term electronic document may be used throughout this document to refer to a set of stored memory states and/or a set of physical signals associated in a manner so as to thereby form an electronic file and/or an electronic document. That is, it is not meant to implicitly reference a particular syntax, format and/or approach used, for example, with respect to a set of associated memory states and/or a set of associated physical signals. It is further noted an association of memory states, for example, may be in a logical sense and not necessarily in a tangible, physical sense. Thus, although signal and/or state components of an electronic file and/or electronic document, are to be associated logically, storage thereof, for example, may reside in one or more different places in a tangible, physical memory, in an embodiment.

The term “computing device,” in the context of the present disclosure, refers to a system and/or a device, such as a computing apparatus, that includes a capability to process (e.g., perform computations) and/or store digital content, such as electronic files, electronic documents, measurements, text, images, video, audio, etc. in the form of signals and/or states. Thus, a computing device, in the context of the present disclosure, may comprise hardware, software, firmware, or any combination thereof (other than software per se). Mobile device 1100, as depicted in FIG. 6, is merely one example, and claimed subject matter is not limited in scope to this particular example.

While mobile device 1100 is one particular example implementation of a computing device, other embodiments of a computing device may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, and/or a display with a higher degree of functionality, such as a touch-sensitive color 2D or 3D display, for example.

Also shown in FIG. 6, mobile device 1100 may comprise digital signal processor(s) (DSP(s)) 1112 connected to the bus 1101 by a bus interface 1110, general-purpose processor(s) 1111 connected to the bus 1101 by a bus interface 1110 and memory 1140. Bus interface 1110 may be integrated with the DSP(s) 1112, general-purpose processor(s) 1111 and memory 1140. In various embodiments, actions may be performed in response execution of one or more executable computer instructions stored in memory 1140 such as on a computer-readable storage medium, such as RAM, ROM, FLASH, or disc drive, just to name a few example. The one or more instructions may be executable by general-purpose processor(s) 1111, DSP(s) 1112, video processor 1168, modem processor 1166 and/or other specialized processors. Memory 1140 may comprise a non-transitory processor-readable memory and/or a computer-readable memory that stores software code (programming code, instructions, etc.) that are executable by processor(s) 1111, DSP(s) 1112, video processor 1168, modem processor 1166 and/or other specialized processors to perform functions described herein. In a particular implementation, wireless transceiver 1121 may communicate with general-purpose processor(s) 1111, DSP(s) 1112, video processor 1168 or modem processor through bus 1101. General-purpose processor(s) 1111, DSP(s) 1112 and/or video processor 1168 may execute instructions to execute one or more aspects of processes, such as discussed above in connection with FIGS. 4A and 4B, for example.

Also shown in FIG. 6, a user interface 1135 may comprise any one of several devices such as, for example, a speaker, microphone, display device, vibration device, keyboard, touch screen, just to name a few examples. In a particular implementation, user interface 1135 may enable a user to interact with one or more applications hosted on mobile device 1100. For example, devices of user interface 1135 may store analog or digital signals on memory 1140 to be further processed by DSP(s) 1112, video processor 1168 or general purpose/application processor 1111 in response to action from a user. Similarly, applications hosted on mobile device 1100 may store analog or digital signals on memory 1140 to present an output signal to a user. In another implementation, mobile device 1100 may optionally include a dedicated audio input/output (I/O) device 1170 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 1100 may comprise touch sensors 1162 responsive to touching or pressure on a keyboard or touch screen device.

Mobile device 1100 may also comprise a dedicated camera device 1164 for capturing still or moving imagery. Dedicated camera device 1164 may comprise, for example a sensor (e.g., charge coupled device or CMOS device), lens, analog to digital circuitry, frame buffers, just to name a few examples. In one implementation, additional processing, conditioning, encoding or compression of signals representing captured images may be performed at general purpose/application processor 1111 or DSP(s) 1112. Alternatively, a dedicated video processor 1168 may perform conditioning, encoding, compression or manipulation of signals representing captured images. Additionally, dedicated video processor 1168 may decode/decompress stored image signals (e.g., states) for presentation on a display device (not shown) on mobile device 1100.

Mobile device 1100 may also comprise sensors 1160 coupled to bus 1101 which may include, for example, inertial sensors and environmental sensors. Inertial sensors of sensors 1160 may comprise, for example accelerometers (e.g., collectively responding to acceleration of mobile device 1100 in three dimensions), one or more gyroscopes or one or more magnetometers (e.g., to support one or more compass applications). Environmental sensors of mobile device 1100 may comprise, for example, temperature sensors, barometric pressure sensors, ambient light sensors, digital imagers, microphones, just to name few examples. Sensors 1160 may generate analog or digital signals that may be stored in memory 1140 and processed by DPS(s) or general purpose/application processor 1111 in support of one or more applications such as, for example, applications directed to positioning or navigation operations.

In a particular implementation, mobile device 1100 may comprise a dedicated modem processor 1166 capable of performing baseband processing of signals received and downconverted at wireless transceiver 1121 or SPS receiver 1155. Similarly, dedicated modem processor 1166 may perform baseband processing of signals to be upconverted for transmission by wireless transceiver 1121. In alternative implementations, instead of having a dedicated modem processor, baseband processing may be performed by a general purpose processor or DSP (e.g., general purpose/application processor 1111 or DSP(s) 1112). It should be understood, however, that these are merely examples of structures that may perform baseband processing, and that claimed subject matter is not limited in this respect.

In the context of the present disclosure, the term “connection,” the term “component” and/or similar terms are intended to be physical, but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other electrical conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, is also used to mean that two or more tangible components and/or the like are not necessarily tangibly in direct physical contact, but are able to co-operate, liaise, and/or interact, such as, for example, by being “optically coupled.” Likewise, the term “coupled” may be understood to mean indirectly connected in an appropriate context. It is further noted, in the context of the present disclosure, the term physical if used in relation to memory, such as memory components or memory states, as examples, necessarily implies that memory, such memory components and/or memory states, continuing with the example, is tangible.

Unless otherwise indicated, in the context of the present disclosure, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Furthermore, the terms “first,” “second” “third,” and the like are used to distinguish different aspects, such as different components, as one example, rather than supplying a numerical limit or suggesting a particular order, unless expressly indicated otherwise. Likewise, the term “based on” and/or similar terms are understood as not necessarily intending to convey an exhaustive list of factors, but to allow for existence of additional factors not necessarily expressly described.

Wireless communication techniques described herein may be employed in connection with various wireless communications networks such as a wireless wide area network (“WWAN”), a wireless local area network (“WLAN”), a wireless personal area network (WPAN), and so on. In this context, a “wireless communication network” comprises multiple devices or nodes capable of communicating with one another through one or more wireless communication links. The term “network” and “communication network” may be used interchangeably herein. A VLC communications network may comprise a network of devices employing visible light communication. A WWAN may comprise a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

Regarding aspects related to a network, including a communications and/or computing network, a wireless network may couple devices, including client devices, with the network. A wireless network may employ stand-alone, ad-hoc networks, mesh networks, Wireless LAN (WLAN) networks, cellular networks, and/or the like. A wireless network may further include a system of terminals, gateways, routers, and/or the like coupled by wireless radio links, and/or the like, which may move freely, randomly and/or organize themselves arbitrarily, such that network topology may change, at times even rapidly. A wireless network may further employ a plurality of network access technologies, including a version of Long Term Evolution (LTE), WLAN, Wireless Router (WR) mesh, 2nd, 3rd, or 4th generation (2G, 3G, or 4G) cellular technology and/or the like, whether currently known and/or to be later developed. Network access technologies may enable wide area coverage for devices, such as computing devices and/or network devices, with varying degrees of mobility, for example.

As used herein, the term “access point” is meant to include any wireless communication station and/or device used to facilitate access to a communication service by another device in a wireless communications system, such as, for example, a WWAN, WLAN or WPAN, although the scope of claimed subject matter is not limited in this respect. In another aspect, an access point may comprise a WLAN access point, cellular base station or other device enabling access to a WPAN, for example. Likewise, as previously discussed, an access point may also engage in VLC communications.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

1. An apparatus comprising:
a digital imager comprising:
an array of pixels, wherein the array of pixels comprises electro-optic sensors, a first type of electro-optic sensors are dedicated to measuring light component signals for an image and a different type of electro-optic sensors are dedicated to measuring visible light communication (VLC) signals.

2. The apparatus of claim 1, and further comprising circuitry to respectively extract, from an image frame or a portion thereof, measured VLC signals and measured light component signals, so that the respectively extracted measured VLC signals and measured light component signals are to be concurrently processed.

3. The apparatus of claim 2, wherein the circuitry to respectively extract the measured VLC signals and the measured light component signals includes separate and distinct respective signal paths, respectively, for the measured VLC signals and for the measured light component signals from the array of pixels.

4. The apparatus of claim 2, wherein the circuitry includes a processor capable of execution of concurrent processing.

5. The apparatus of claim 2, wherein the digital imager comprises a component of a mobile communication device.

6. (canceled)

7. (canceled)

8. The apparatus of claim 1, wherein the different type of electro-optic sensor comprises photodiodes.

9. (canceled)

10. An article comprising: a non-transitory storage medium including executable instructions stored thereon, the instructions being accessible from the non-transitory storage medium as physical memory states on one or more physical memory devices, the one or more physical memory devices to be coupled to one or more processors able to execute the instructions stored as physical memory states, one or more of the physical memory devices also able to store binary digital signal quantities, if any, as physical memory states, that are to result from execution of the executable instructions on the one or more processors;
wherein the executable instructions to measure one or more light signals to impinge upon an array of pixels, wherein the array of pixels comprises electro-optic sensors, a first type of electro-optic sensors of the array of pixels being dedicated to measure light component signals for an image and a different type of electro-optic sensors of the array of pixels being dedicated to measure visible light communication (VLC) signals.

11. The article of claim 10, wherein the array of pixels comprises a component of a digital imager and wherein the digital imager comprises a component of a mobile phone.

12. The article of claim 10, wherein the instructions are further to extract measured VLC signals and to extract measured light component signals from an image frame, or a portion thereof, so that the respectively extracted measured VLC signals and the measured light component signals are to be concurrently processed.

13. The article of claim 10, wherein the instructions are further to measure one or more light signals impinging upon the different type of electro-optic sensors of the array of pixels dedicated to measure VLC signals.

14. The article of claim 13, wherein the instructions are further to process measured VLC signals impinging upon the different type of electro-optic sensors dedicated to measure VLC signals.

15. The article of claim 14, wherein the instructions are further to demodulate the measured VLC signals.

16. (canceled)

17. The article of claim 10, wherein the different type of electro-optic sensors comprises photodiodes.

18. (canceled)

19. A device comprising:
means for exposing an array of pixels to one or more light signals; and
means for measuring at least a portion of the one or more light signals impinging upon the array of pixels, wherein the array of pixels comprises electric-optic sensors, a first type of electro-optic sensors of the array of pixels are dedicated to measure light component signals for an image and a different type of electro-optic sensors of the array of pixels are dedicated to measure visible light communication (VLC) signals.

20. The device of claim 19, and further comprising means for respectively extracting measured VLC signals and extracting measured light component signals from an image frame or a portion thereof, so that the respectively extracted measured VLC signals and the measured light component signals are to be concurrently processed.

21. The device of claim 19, wherein the means for measuring at least a portion of the one or more light signals impinging upon the array of pixels comprises selective means for measuring one or more light signals impinging upon the at least other pixels of the array of pixels dedicated to measure VLC signals.

22. The device of claim 21, and further comprising means for processing measured VLC signals impinging upon the at least other pixels of the array of pixels dedicated to measure VLC signals.

23. (canceled)

24. The device of claim 19, wherein the different type of electro-optic sensors of the array of pixels comprises photodiode sensors.

25. (canceled)

26. A method, at a computing device, comprising:
measuring light signals impinging upon an array of pixels in a digital imager, wherein the array of pixels comprises electro-optic sensors, a first type of electro-optic sensors of the array of pixels being dedicated to measure light component signals for an image and a different type of electro-optic sensors of the array of pixels being dedicated to measure visible light communication (VLC) signals; and
processing measured VLC signals impinging upon the different type of electro-optic sensors of the array of pixels dedicated to measure VLC signals.

27. The method of claim 26, wherein the processing the measured VLC signals includes demodulating the measured VLC signals.

28. The method of claim 27, wherein the demodulating the measured VLC signals includes decoding to obtain one or more symbols.
